(19) United States
(12) Patent Application Publication
(10) Pub. No.: US 2025/0116315 A1
(43) Pub. Date: Apr. 10, 2025

(54) Compact Stepped Linear Drive

(71) Applicant: CBN Nano Technologies Inc., Ottawa (CA)

(72) Inventors: James MacArthur, Stockport (GB); Matthew Moses, Lafayette, CO (US); Ralph C. Merkle, Santa Clara, CA (US)

(21) Appl. No.: 18/481,777

(22) Filed: Oct. 5, 2023

(51) Int. Cl. F16H 21/44; F16H 25/12; F16H 25/18

(52) U.S. Cl. CPC F16H 21/44; F16H 25/12; F16H 25/183

(57) ABSTRACT

To provide a stepped linear drive with a compact overall volume, a drive can employ control elements which engage and disengage an output element without being displaced normal to the axis of output motion.

### CROSS-REFERENCE TO RELATED APPLICATIONS

None.

### TECHNICAL FIELD

The present application relates to linear drives which translate an output in steps, allowing the overall throw of output motion to be greater than the throw of the actuators employed to impart movement.

### BACKGROUND

Stepped linear drives use repeated steps to move an output a distance greater than the throw of the actuator(s) employed. In general, an actuator is mechanically coupled to the output and extended or retracted to move the output a single step. The actuator is then decoupled from the output, reset to its original position, and the procedure repeated as many times as necessary to move the output the desired displacement. This allows an actuator having a limited distance of throw to move the output a much greater distance.

One class of stepped linear drives is an “inchworm motor” that uses piezoelectric actuators to move an output with nanometer precision. In a typical form, the inchworm motor uses three piezo-actuators that are electrified in sequence to expand and contract them in order to grip the output and move it along an axis. Such an inchworm motor can operate in a repeated six-step sequence, which starts with a first grip actuator (formed by an opposed pair of piezoelectric elements located at one end of an axial actuator) extended to clamp the output therebetween. The axial actuator is extended, moving the clamped output in the direction of extension. A second grip actuator (formed by an opposed pair of piezoelectric elements located at the other end of the axial actuator) is extended to clamp the output, and the first grip actuator is retracted to release its grip on the output. The axial actuator is then retracted, which moves the output clamped by the second grip actuator further in the original direction. The first grip actuator is then extended to grip the output, and the second grip actuator is retracted to release its grip, leaving the drive configured to repeat the sequence.

### SUMMARY

The following Summary is provided to aid in understanding the novel and inventive features set forth in the appended claims, and is not intended to provide a complete description of the inventive features. Thus, any limitations of the following summary should not be interpreted as limiting the scope of the appended claims.

When using stepped linear drives in micro-scale or nano-scale mechanisms, overall size is a concern. Conventional drives which employ opposed clamping elements that move normal to the axis of output motion require a significant space to accommodate such laterally-moving elements. Applicant has developed stepped linear drives which do not rely on laterally-moving elements to engage the output, and thus can be constructed with a smaller overall volume.

A stepped linear drive mechanism may have an output element that is translatable along a motion axis, a first control element that is translatable parallel to the motion axis, and a second control element that is translatable parallel to the motion axis. The first control element is selectively engageable with the output element, and may have at least a portion that is restrained in space so as to have a fixed position relative to a plane orthogonal to the motion axis; that is, such portion is limited to motion along or about an axis parallel to the motion axis. Similarly, the second control element is selectively engageable with the output element and may have at least a portion that is restrained in space so as to have a fixed position relative to a plane orthogonal to the motion axis; that is, such portion does not translate except in a direction parallel to the motion axis and, if it rotates, only rotates about an axis parallel to the motion axis. The selective engagement of the first control element and the second control element with the output element allows the output element to be moved with the control elements when both control elements are translated parallel to the motion axis, and allows one of the control elements to be moved (to reposition it) while the other of the control elements and the output element remain stationary. This allows the control elements to move the output element a step along the motion axis, then be individually repositioned before moving the output element another step, until the output element has been placed in a desired position along the motion axis.

In some cases, the first control element and the second control element are each restrained so as to only be translatable along the motion axis. The first control element and the second control element may resiliently engage the output element via impedance structures; in such cases, an additional element may be provided (either a third translating control element or a stationary element) with an impedance structure, and selective engagement is achieved by moving two control elements together (in which case their combined impedance is greater than the impedance of the remaining element and the output element moves with the control elements, engaged therewith by their greater impedance). When one of the control elements is moved individually, the combined impedance of the other control element and the additional element is greater (in which case the greater impedance disengages the moving control element from the output element, allowing it to be moved while the other control element and the additional element restrain the output element in place).

The first control element and the second control element can selectively engage the output via tabs bounded by cam elements (such as cam surfaces or cam edges) and restraining elements (such as restraining surfaces or restraining edges). In such cases, the output element can be provided with an output effector that is forced into engagement with one of the tabs by translation of one of the control elements. The output effector may translate along an axis normal to the motion axis or may pivot about the motion axis, so as to become engaged with one of the tabs. The control elements can be moved to trap the output effector in the tab by a restraining element, after which both control elements can be moved to move the output element a step.

In some cases, the control elements each can translate along and rotate about a control axis that is parallel to the motion axis. Such control elements may employ protrusions engage the output element or may employ edges that engage the output element via van der Waals attraction.

A stepped linear drive mechanism may have an output element that is translatable along a motion axis, a first control element that is translatable parallel to the motion axis and is rotatably engageable with the output element, and a second control element that is rotatably engageable with the output element and capable of restraining translation of the output element when engaged with it. The engagement of the first control element with the output element can allow the first control element to translate the output element when the first control element is so engaged and the output element is not restrained by the second control element. Disengagement of the first control element allows it to translate (to reposition it) while the output element is restrained by the second control element. The second control element may operate in the same manner as the first control element, engaging the control element to either move it (together with the first element) or restrain it from moving, and disengaging from the output element to allow the second control element to move (to reposition it) while the output element is restrained by engagement with the first control element. In some cases the second control element does not translate, and is limited to only rotating or only pivoting through a limited angle (such as 90 degrees); in such cases, the second control element can engage the output element to restrain it from moving, or disengage from the output element to allow it to be translated by the first control element. Again, the control elements may employ protrusions engage the output element or may employ edges that engage the output element via van der Waals attraction.

A method of moving an output element along a motion axis may comprise the steps of engaging the output element with a first control element without requiring translational motion of the control element normal to the motion axis, translating the first control element parallel to the motion axis so as to also translate the output element engaged therewith, disengaging the output element from the first control element and engaging the output element with a second control element without requiring translational motion of the second control element normal to the motion axis, repositioning the first control element parallel to the motion axis while engagement of the output element with the second control element prevents the output element from translating along the motion axis, and repeating the engaging, translating, disengaging, and repositioning steps until the output element has been translated to a desired position on the motion axis. The method may include the steps of disengaging the second control element and repositioning it while the output element is held in place by engagement with the first control element. The step of engaging the output element with each control element may performed without translating the control element, such as by rotating the control element.

### BRIEF DESCRIPTION OF THE FIGURES

FIGS. 1-4 illustrate a stepped linear drive having two control elements that resiliently engage an output element. Moving both control elements in combination overcomes the impedance caused by engagement of a stationary element with the output element, causing the output element to move with the control elements. If only one control element is moved, the combined impedance of the other control element and the stationary element holds the output element in place, allowing the control elements to be individually repositioned.

FIG. 5 illustrates a stepped linear drive mechanism that again employs two control elements and a stationary element that engage an output via impedance structures, but where resilient engagement is provided by resiliently mounting an output impedance element to the output element, allowing the control elements to be rigid and limited to only translational movement.

FIG. 6 illustrates a stepped linear drive that operates similarly to the drives shown in FIGS. 1-5, but where the elements are fabricated from modified carbon nanotubes (CNTs) to facilitate fabricating a nanoscale drive.

FIGS. 7-11 illustrate a stepped linear drive that employs control elements having tabs bounded by cam surfaces to selectively engage with and disengage from an output element. The output element has a transversely-movable output effector that can be forced into one of the tabs to engage the output with one of the control elements. Impedance of axial motion of the output element from connected structure (not shown) makes transverse motion of the output effector preferred when one of the control elements is translated.

FIG. 12 illustrates a stepped linear drive that operates similarly to the drive shown in FIGS. 7-11, but where the control elements are flat and engage the output element via van der Waals (VDW) attraction. The drive can be formed from CNTs, graphene, and/or blocks fabricated from diamond, Lonsdaleite, or similar materials to facilitate fabricating a nanoscale drive.

FIG. 13 illustrates a stepped linear drive that is similar to the drive shown in FIG. 12, but where the control elements are semi-cylindrical and the output effector pivots rather than translates to engage a tab on one of the control elements.

FIGS. 14-18 illustrate a stepped linear drive that employs control elements that rotate to engage with and disengage from the output element. The control elements are each provided with a series of protrusions that can be rotated into engagement with the output element in order to either move it with the control element or hold it in place while the other control element is repositioned. In this drive, each of the control elements can both rotate and translate about a control axis that is parallel to the axis along which the output element moves.

FIGS. 19-20 illustrate a stepped linear drive that is similar to that shown in FIGS. 14-18, but where only one of the control elements translates, while the other control element rotates to engage with and disengage from the output element, but does not translate.

FIG. 21 illustrates a stepped linear drive which can operate similarly to one of the drives shown in FIGS. 14-20, but where the control elements engage the output element via VDW attraction. Rather than protrusions, each control element is provided with a series of holes that create edges to engage the output element. When rotated such that the holes bracket the output element, moving the output element past the edge of one of the holes would require work to overcome the VDW attraction.

FIG. 22 illustrates a demultiplexer for directing a motion signal from an input to one of several channels. To direct the input motion signal to the desired channel, a stepped linear drive that operates similarly to those shown in either FIGS. 14-18 or FIGS. 19-20 is employed to move an output to align it with the selected channel.

FIG. 23 illustrates one example of a control motor that could be used to operate one of the control elements such as shown in FIGS. 14-22 to provide rotational and translational motion.

FIG. 24 illustrates the steps of a method for moving an output along an axis in a stepwise manner.

### DETAILED DESCRIPTION

The drawings and accompanying descriptions illustrate several examples of stepped linear drives that can be built more compactly than drives which employ laterally-displaced clamping elements to engage an output. Many of these drives offer simplified structures, fewer parts, and/or smaller size compared to prior art drives, and many are well-suited to micro-scale and nano-scale fabrication. While particular examples are illustrated, alternative arrangements that employ the same principles and functionality could be designed using variations on the specific examples. It should be noted that in many cases, for reasons of clarity, additional conventional elements employed to constrain the motion of elements in mechanical devices are not shown, such elements including (but not limited to) anchoring structures, guiding structures, actuator motors, etc. While many of the examples shown are for structures scaled to be fabricated by conventional manufacturing techniques (including micro- and nano-scale lithography), equivalent molecular-scale and atomically-precise structures could be formed having an analogous arrangement of parts.

A linear drive mechanism has an output element that translates along a motion axis, and at least two control elements that each extend parallel to the motion axis are selectively engageable with the output. At least one of the control elements is translatable parallel to the motion axis. To provide a compact drive mechanism, the control elements engage the output in such a manner that they are brought into and out of engagement primarily by motion that is directed along or about axes that are parallel to the motion axis, rather than being displaced in a direction normal to or substantially normal to the motion axis. The selective engagement of the control elements with the output allows the output to move with one or both of the control elements when the control elements are translated along the motion axis, and allows one of the control elements to be moved (to reposition it) while the other of the control elements and the output element remain stationary.

In some drive mechanisms, both control elements are translatable parallel to the motion axis and each has at least a portion that is restrained in space so as to have a fixed position relative to a plane orthogonal to the motion axis; that is, such portion is limited to motion along or about a control axis that is parallel to the motion axis. In some cases, motion of the control elements is limited to translation parallel to the motion axis. In some cases, the control elements each resiliently engage the output, each snapping into position with respect thereto at one of a number of discrete positions. Such resilient engagement could be provided by resilient flexibility incorporated into the control elements or by resiliently mounting the output to surrounding structure, or a combination of both. In some cases, each of the control elements engages the output via tabs bounded by cam elements (such as surfaces or edges), where the output is configured to be moved by one of the cam surfaces of one control element into engagement with a tab on the other, where it can be trapped by a restraining element (such as a surface or edge). In some cases, the control elements each rotate about their axis of translation to engage with and disengage from the output without being laterally displaced.

In some drive mechanisms, both control elements rotate about an axis parallel to the motion axis to engage with and disengage from the output. At least one of the control elements is translatable along its axis of rotation, allowing it to translate the output element when engaged therewith and when the output element is not restrained by the other control element, and allowing it to translate back to its original position when disengaged from the output, while the output is restrained by engagement with the other control element. In some such mechanisms, both control elements translate, while in others, one control element only rotatably engages with and disengages from the output element, but does not translate.

An output element can be moved along a motion axis by first engaging the output element with a first control element in such a manner that the engagement action does not require translating the first control element normal to the motion axis. Depending on the configuration of the output element and the first control element, such engaging step could result from translating the first control element parallel to the motion axis or by rotating it about an axis that is parallel to the motion axis. Once the first control element and the output element are engaged, the first control element is translated parallel to the motion axis, also translating the output element with it. After this translating step, the output element is disengaged from the first control element and engaged with the second control element, where the engagement of the second control element is done in such manner that it does not require translational motion of the second control element normal to the motion axis. Again, such engaging step could result from translating the second control element parallel to the motion axis or by rotating it about an axis that is parallel to the motion axis. In some cases, the second control element is already engaged with the output element, having translated along with the first control element. Once the output element is engaged with the second control element and disengaged from the first control element, the first control element can be repositioned by translating it parallel to the motion axis, while engagement of the output element with the second control element prevents the output element from translating with the first control element. The first control element is positioned to repeat the sequence, and the sequence can be repeated as many times as necessary to move the output the desired distance along the motion axis. In cases where the second control element translates with the first control element to move the output element, once the first control element has been repositioned and re-engaged with the output element, the second control element is disengaged from the output element and repositioned while engagement of the output element with the first control element holds the output element in position. In such cases, the second control element can then be re-engaged with the output element and translated with the first control element to provide more balanced forces to move the output element. In other cases, the second control element is not repositioned; in such cases, the second control element is disengaged from the output element before the first control element is translated to advance the output element in the desired direction along the motion axis.

One application of such drive mechanisms is for channel selection in a mechanical multiplexer or demultiplexer, such as those disclosed in US Publication 2023/0296163, incorporated herein by reference.

In many cases, drive mechanisms of the present invention can be implemented with control elements that have consistent overall dimensions, without reliance on elements that expand and contract to engage and/or move an output. In some cases, the control elements can be formed from rigid structures.

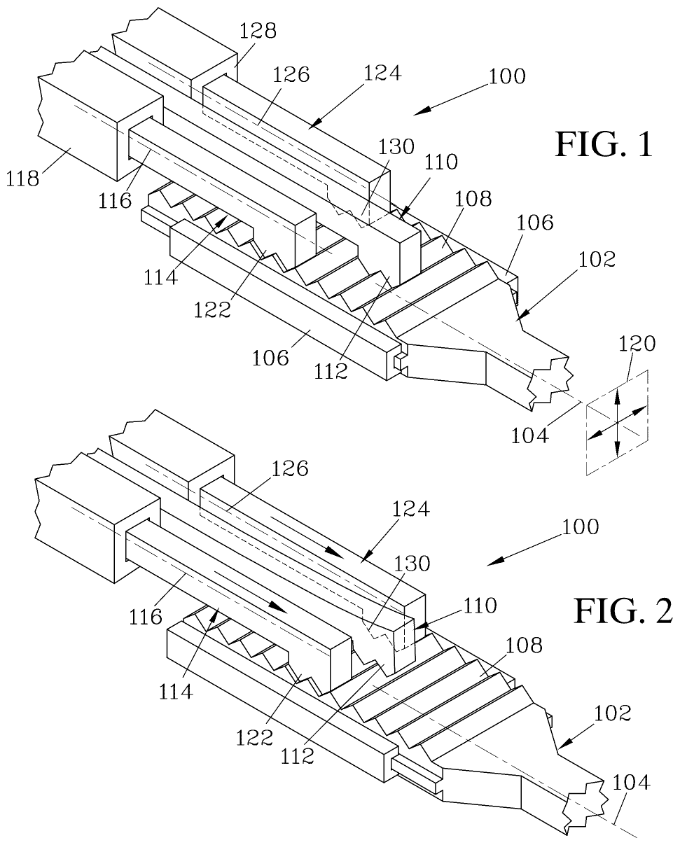

FIGS. 1-4 show an example of a linear drive mechanism 100 having an output element 102 that is translatable along a motion axis 104, its motion in this example being constrained by rails 106. The output element 102 has an output impedance structure 108, which in the drive 100 is formed as a sawtooth. A stationary element 110 is provided, having a stationary impedance element 112 that is configured to resiliently engage the output impedance structure 108. Typically, such resilience is provided by a degree of resilient flexibility in the material from which the stationary element 110 is fabricated.

A first control element 114 is provided, which is translatable along a first control axis 116 that is parallel to the motion axis 104. Motion of the first control element 114 is limited to translation along the first control axis 116 by a first sleeve 118, and thus the portion of the first control element 114 that engages the first sleeve 118 has a fixed position relative to a reference plane 120 that is orthogonal to the motion axis 104. The first control element 114 has a first control impedance element 122 that is resiliently engageable with the output impedance structure 108. As with the stationary element 110, such resilience can be provided by a degree of resilient flexibility in the material from which the first control element 114 is fabricated.

A second control element 124 provided, which is translatable along a second control axis 126 that is parallel to the motion axis 104 and the first control axis 116. Motion of the second control element 124 is limited by a second sleeve 128, which restrains the portion of the second control element 124 that engages the first sleeve 128 such that it has a fixed position relative to the reference plane 120. The second control element 124 has a second control impedance element 130 that is resiliently engageable with the output impedance structure 108. Again, such resilience can be provided by a degree of resilient flexibility in the material used to fabricate the second control element 124.

To move the output element 102, both control elements (114, 124) are translated together, as shown in FIG. 2; such translation can be provided by appropriate linear actuators (not shown) or similar means. By translating both control elements (114, 124), the combined impedance of both control impedance elements (122, 130) with the output impedance structure 108 is greater than the impedance of the single stationary impedance element 112 (the stationary element 110 is shown slightly deflected in FIG. 2 due to the engagement of the output impedance structure 112 with the output impedance structure 108). This difference in impedance causes0. selective engagement of the control elements (114, 124) with the output element 102, and allowing the output element 102 to move with the control elements (114, 124). Once the control elements (114, 124) have been translated a step, advancing the output element 102 along the motion axis 104, they are individually translated back to their initial positions. As shown in FIG. 3, the first control element 114 is translated along its first control axis 116. At this time, the second control element 124 remains fixed, and the combined impedance of the second control impedance element 130 and the stationary impedance element 112 with the output impedance structure 108 is greater than the impedance of the single first control impedance element 122, and this greater impedance acts to disengage the first control element 114 from the output element 102, allowing the first control element 114 to be repositioned while the second control element 124 and the output element 102 remain stationary. Once the first control element 114 has been repositioned, it is held stationary while the second control element 124 is translated back to its initial position, as shown in FIG. 4. The combined impedance of the first control impedance element 122 and the stationary impedance element 112 is greater than the impedance of the single second impedance element 130 with the output impedance structure 108, and thus the output element 102 remains stationary and the second control element 124 is effectively disengaged from the output element 102 so that the second control element 124 can be returned to its initial position. This sequence of actions, translating the control elements (114, 124) together and then individually repositioning them can be repeated as many times as needed to advance the output 102 the desired number of steps along the motion axis 104. While only motion in one direction is shown, it should be appreciated that motion in the other direction can be achieved by individually disengaging and positioning each of the control elements and then translating them together in the other direction back to their initial positions.

While shown as having a stationary element and two control elements, a variation could be employed having three translating control elements, one replacing the stationary element. In such a drive, the output would move or remain stationary when any two of the three control elements are translated or held stationary.

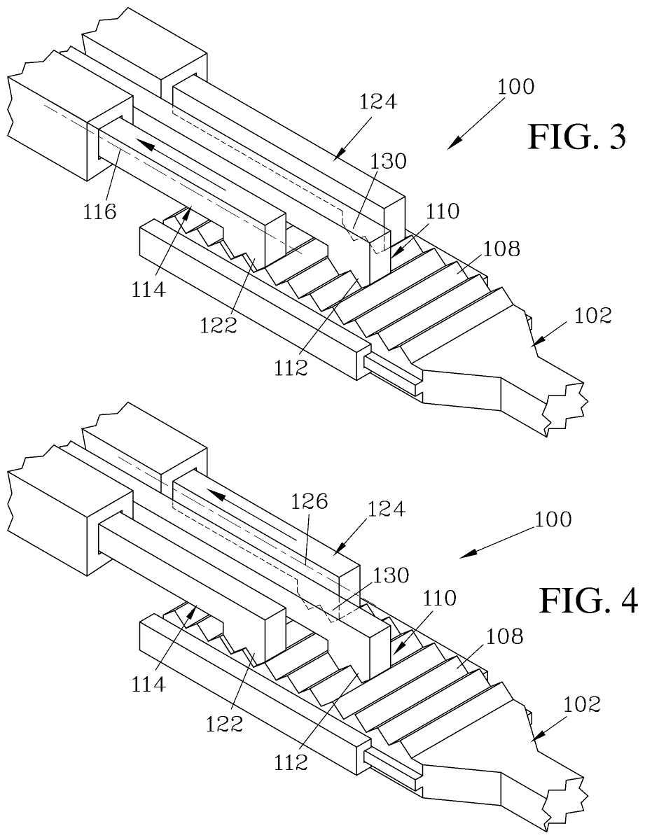

FIG. 5 shows one example of a linear drive mechanism 150 which operates similarly to the drive 100, but where an output element 152 is resiliently mounted to an output support 154. A stationary element 156, a first control element 158, and a second control element 160 are provided, but in the drive 150 these elements (156, 158, 160) can be rigid. As the control elements (158, 160) are translated, resilient engagement of a stationary impedance element 162 and control impedance elements (164, 166) with an output impedance structure 168 is provided by the resilient mounting of the output element 152 to the output support 154, rather than by resilient flexibility of the stationary element and the control elements as in the drive 100.

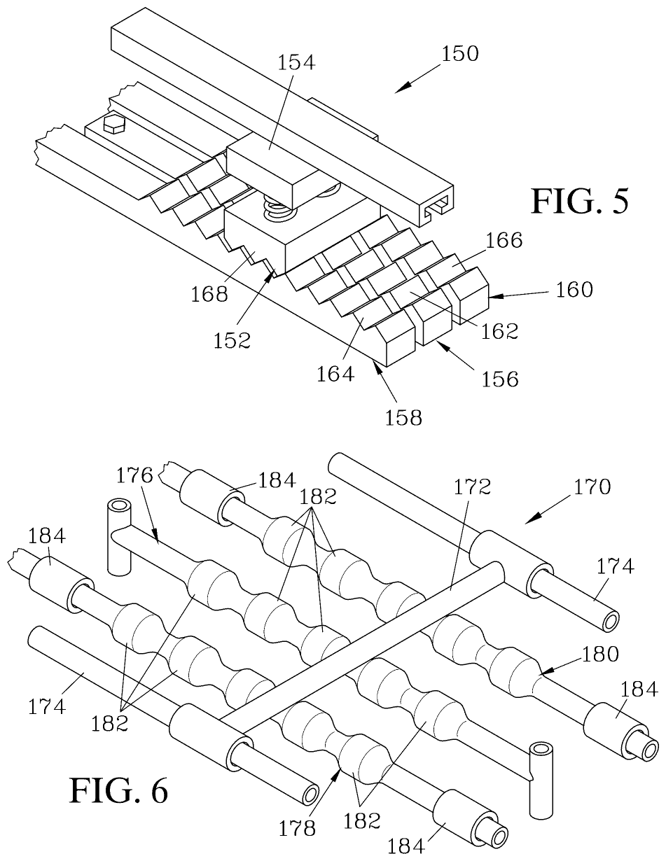

FIG. 6 shows one example of a linear drive mechanism 170 which operates similarly to the drives 100 and 150, but which is designed for molecular-scale fabrication using modified carbon nanotubes (CNTs). An output element 172 is formed by a 5-5 CNT joined to larger CNT sleeves that are guided along rails 174, while a stationary element 176, a first control element 178, and a second control element 180 are each formed by CNTs that transition between 5-5 sections and 10-10 sections, providing expanded regions 182 that provide impedance elements that can engage the output element 172. Guide sleeves 184 of 18-0 CNT sections limit the motion of the control elements (178, 180), and the resilient flexibility of the elements (172, 176, 178, 180) allows the control elements (178, 180) to resiliently engage the output element 172.

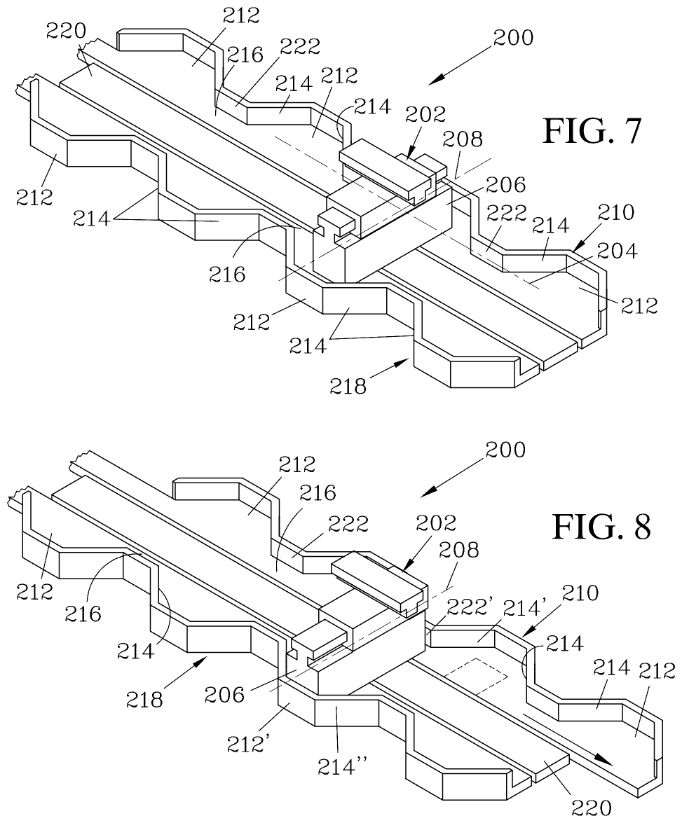

FIGS. 7-11 show one example of a linear drive mechanism 200 having an output element 202 that translates along a motion axis 204. The output element 202 has an output effector 206 that can translate on a transverse axis 208 that is orthogonal to the motion axis 204. Resistance provided by further elements (not shown) connected to the output 202 impedes motion along the motion axis 204, such that it is easier for the output effector 206 to move along the transverse axis 208 than to be displaced along the motion axis 204.

A first control element 210 is translatable parallel to the motion axis 204, and is provided with a series of tabs 212 bounded by cam surfaces 214, and a continuous region 216. Similarly, a second control element 218 is translatable parallel to the motion axis 204 and is also provided with a series of tabs 212 bounded by cam surfaces 214 and a continuous region 216. The control elements (210, 218) can each be moved by a conventional actuator (not shown). A stationary element 220 separates the control elements (210, 216). The tabs 212 are separated by restraining surfaces 222 that bound the continuous region 216.

The dimensions of the tabs 212 and the continuous regions 216 of the control elements (210, 218) are selected relative to the dimensions of the output effector 206 such that only one of the control elements (210, 218) can translate without also translating the output effector 206 along the motion axis 204. This is because one of the tabs 212 on either control element (210, 218) provides sufficient space to accommodate the output effector 206 while the continuous region 216 on the other control element (210, 218) translates past it with the cam surfaces 214 on that control element (210, 216) clearing the end of the output effector 206. If one of the control elements (210, 216) is translated while the other remains stationary, the cam surfaces 212 on the moving control element (210, 216) act to push the output effector 206 into an opposed tab 212 on the static control element (210, 216).

To illustrate the steps of moving the output element 202 along the motion axis 204, FIG. 8 shows the first control element 210 translated from its initial position as shown in FIG. 7. For purposes of illustration, the original position of the output effector 206 with respect to the control elements (210, 218) and the static element 220 is indicated in dashed lines in FIGS. 8-11. Translation of the first control element 210 brings the cam surface 214′ into engagement with the output effector 206, forcing it to move. Because of resistance to translation of the output element 202, the output effector 206 preferentially moves into tab 212′ on the second control element 218, thereby selectively engaging the second control element 218 with the output element 202. With this engagement, both control elements (210, 218) can then be translated together, as shown in FIG. 9, moving the output element 202 via engagement of cam surface 214″ on the second control element 218 with the output effector 206. Engagement is maintained as the continuous region 216 of the first control element 210 is narrow enough to allow the restraining surface 222′ on the first control element 210 to trap the output effector 206 in the tab 212′. Note that the initial move of the first control element 210 is half the distance needed to move the output element 202 an entire step (the distance from one pair of opposed tabs 212 to the next).

Once the output element 202 has been translated a step, the first control element 210 can be returned to its original position as shown in FIG. 10. This places the tab 212″ on the first control element 210 in a position to accept the output effector 206 (no longer restrained by the restraining surface 222′), allowing space for the second control element 218 to be moved past to return it to its original position, as shown in FIG. 11. During this motion, cam surface 214″ moves the output effector 206 into the tab 212″ a sufficient distance to allow the continuous region 216 of the second control element 218 to move past the control effector 206. This motion essentially disengages the output element 202 from the second control element 218 and engages it with the first control element 210, allowing the first control element 210 to hold the output 202 in position while the second control element 218 resets to its original position. After the second control element 218 has been returned to its original position, both control elements (210, 218) are in their original positions, but the output element 202 has been moved one step to reside between a different pair of tabs 212 than in FIG. 7. Movement of the output element 202 in the opposite direction can be achieved by adjusting the sequence of events to individually position the control elements (210, 218) before engaging the output element with one of them to translate it by combined motion of the control elements (210, 218) in the other direction.

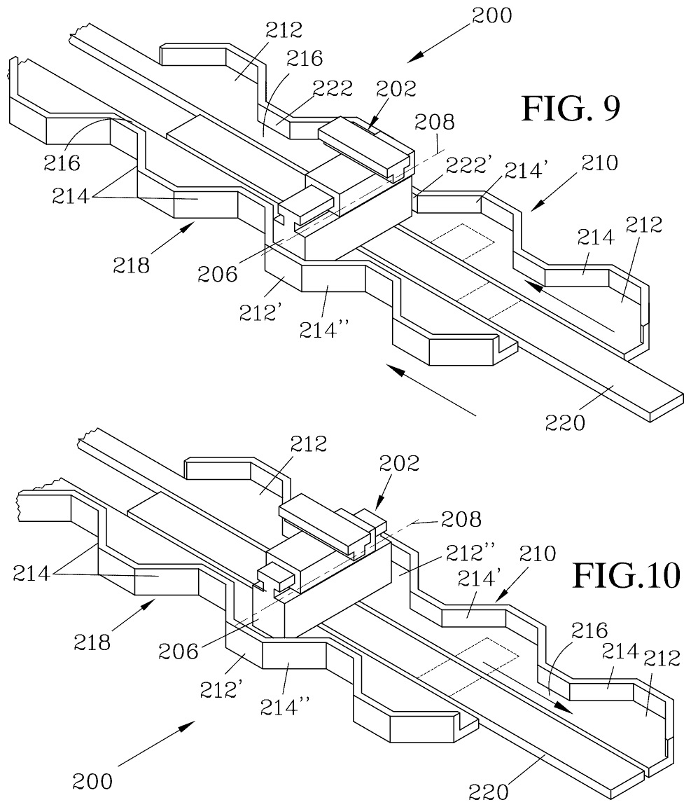

FIG. 12 shows a linear drive mechanism 230 that is functionally similar to the mechanism 200, but which is suitable for molecular-scale fabrication using CNTs, blocks of diamond, Lonsdalite, or similar materials, and/or shaped graphene sheets. In the drive 230, the control elements 232 have tabs 234 that are bounded by cam edges 236, which engage an output effector 238 of an output element 240 via van der Waals (VDW) attraction. Because moving the output effector 238 past the cam edge 236 would require work to overcome the VDW attraction between the output effector 238 and the tab 234, the output effector 238 moves into a tab 234 on the other control element 232 in order to avoid such work. The output effector 238 can then be maintained in engagement with the tab 234 by a restraining edge 242 on the other control element 232. The use of VDW attraction to move parts via a camming action and to limit motion of parts is disclosed in US Publication 2023/0238965, incorporated herein by reference. FIG. 12 also shows a pair of linear actuators 244 (not necessarily shown to scale) that could be employed to move the control elements 232. Electrostatic comb actuators are illustrated, but other actuators could be employed. While not shown, similar actuators can be used to move the control elements in other stepped drive mechanisms disclosed herein.

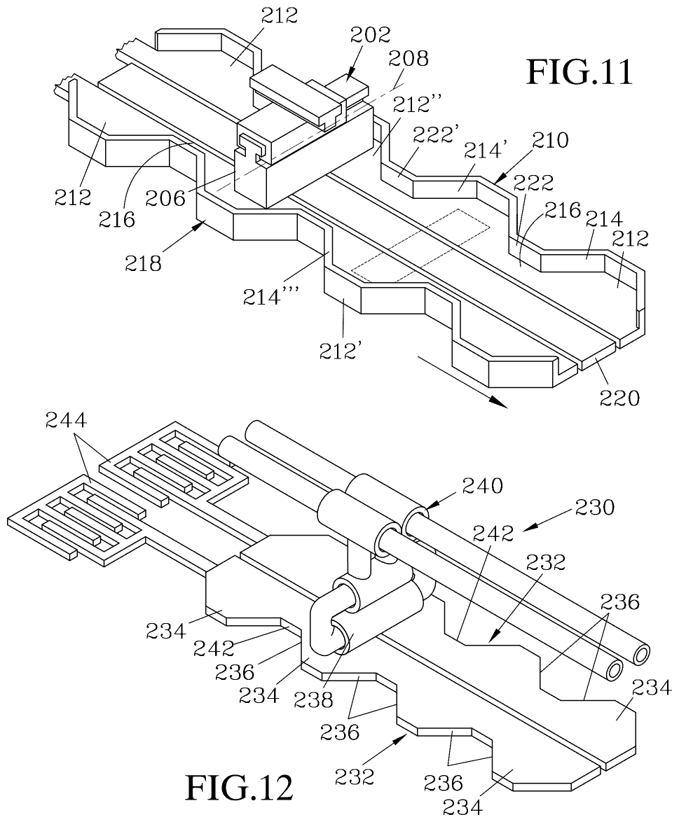

FIG. 13 shows a linear drive mechanism 250 that operates similarly to the drive 230, but where an output 252 has an output effector 254 that pivots about a motion axis 256 rather than translating along a transverse axis. Two semi-cylindrical control elements 258 are provided, each with tabs 260 bounded by cam edges 262 and separated by restraining edges 264. Moving one of the control elements 258 while the other remains in place acts to pivot the output effector 254 into engagement with a tab 260 on the other control element 258. Axial motion of the output effector 254 is transmitted via an output shaft 266 that is movably mounted to the output effector 254.

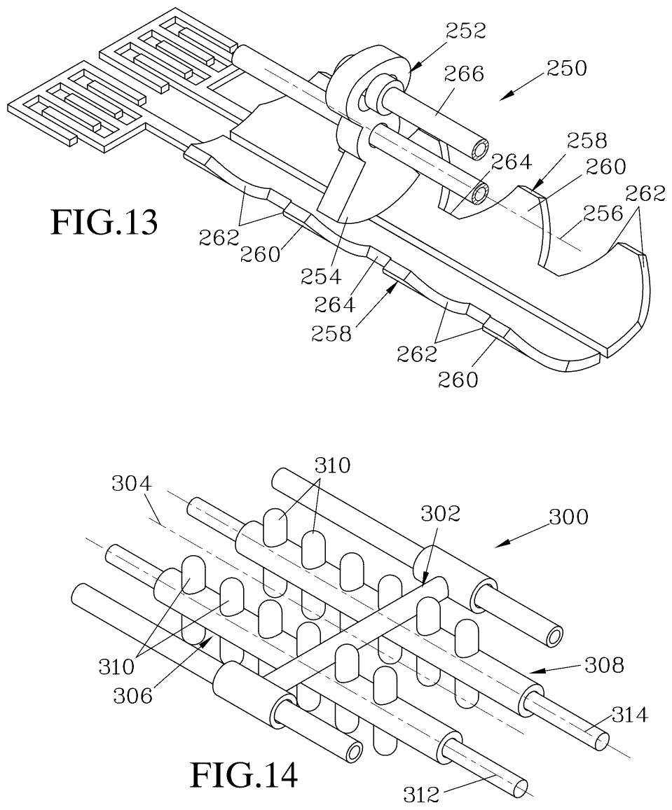

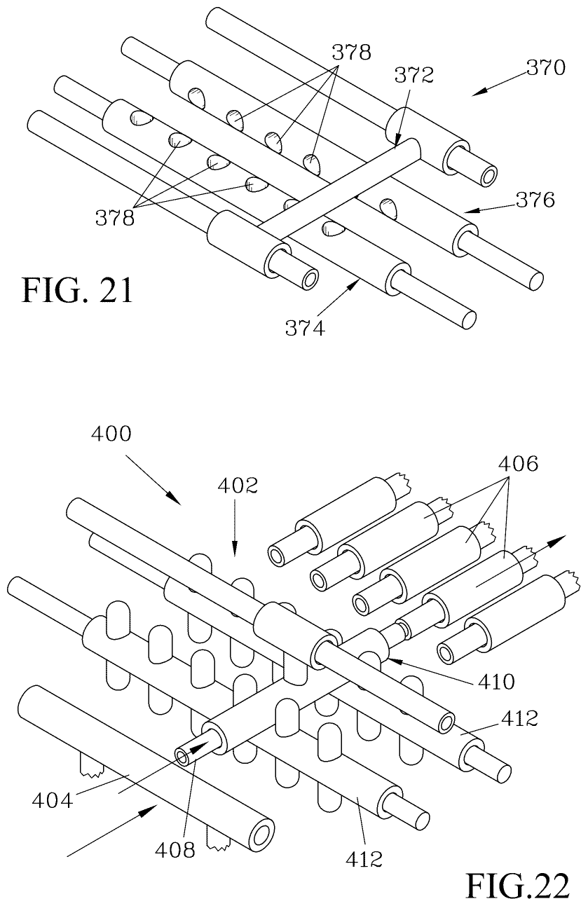

FIGS. 14-18 show one example of a linear drive mechanism 300 having an output element 302 that translates along a motion axis 304, a first control element 306, and a second control element 308. In the drive 300, the control elements (306, 308) each rotate into and out of engagement with the output element 302; this simplifies the structure of the drive 300, but does place greater requirements on the actuators employed to operate the control elements (306, 308), as the actuators must provide both rotational and translational motion (one example of a control motor that could be used for providing such motion is shown in FIG. 23). The drive 300 is shown as suitable for molecular-scale fabrication using modified CNTs.

The first control element 306 is provided with a series of protrusions 310 and is constrained to rotate about and translate along a first control axis 312 that is parallel to the motion axis 304. Similarly, second control element 308 is provided with protrusions 310 and is constrained to rotate about and translate along a second control axis 314 that is parallel to the motion axis 304 and the first control axis 312. The protrusions 310 are arranged in rows along the control elements (306, 308), such that either of the control elements (306, 308) can be rotated such that a pair of the protrusions 310 bracket the output element 302, or rotated such that the protrusions 310 can be translated past the output element 302 (as shown for the first control element 306 in FIG. 16 and shown for the second control element 308 in FIG. 17).

To move the output element 302, the control elements (306, 308) are rotated so as to engage the control elements (306, 308) with the output element 302, as shown in FIG. 14. The control elements (306, 308) are then translated together to move the output element 302 one step, as shown in FIG. 15. As shown in FIG. 16, the first control element 306 is then rotated about the first control axis 312 to disengage its protrusions 310 from the output element 302, after which it can be returned to its initial position by translating it along the first control axis 312, while the engagement of the second control element 308 with the output element 302 holds it in place. Once returned to its initial position, the first control element 306 can be rotated to engage it with the output element 302, and the second control element 308 can be returned to its position by rotating it about the second control axis 314 to disengage it from the output element 302 and then translating it back to its initial position (as shown in FIG. 17), while the output element 302 is held in place by engagement with the first control element 306. Once repositioned, the second control element 308 can be rotated to re-engage it with the output element 302 (as shown in FIG. 18), ready for both control elements (306, 308) to move the output element 302 another step if necessary to place the output element 302 into the desire position along the motion axis 304. Motion in the reverse direction can be accomplished by individually disengaging and translating each of the control elements (306, 308) to position them relative to the output element 302, and then translating them both to their initial positions, moving the output element 302 a step in that direction.

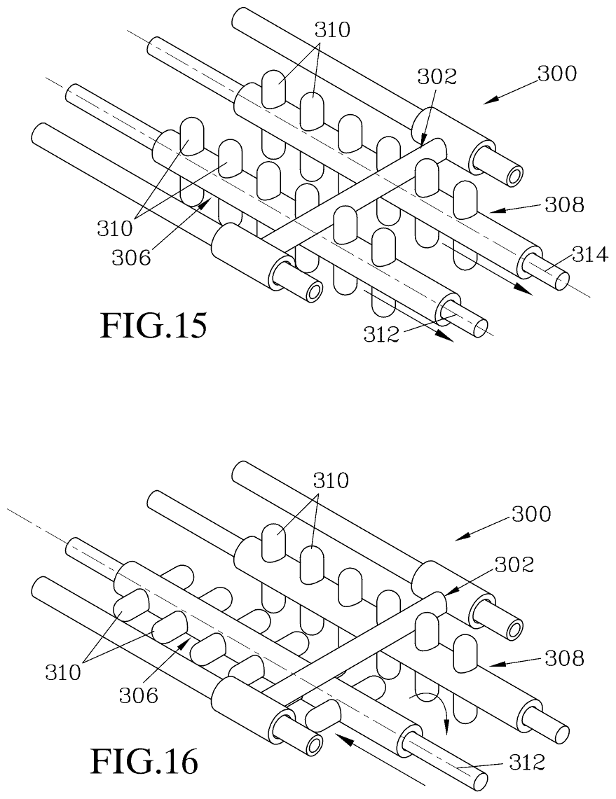

FIGS. 19-20 show a linear drive mechanism 350 that is structurally very similar to the drive 300, but which employs a different scheme for moving an output element 352 along a motion axis 354. The drive 350 again has a first control element 356 and a second control element 358, each provided with protrusions 360 that can be rotated to engage or disengage the control elements (356, 358) with the output element 352. The first control element 356 is again movable to rotate about and translate along a first control axis 362 that is parallel to the motion axis 354.

In the drive 350, the second control element 358 can be rotated about a second control axis 364 that is parallel to the motion axis 354 and the first control axis 362, but does not translate along second control axis 364. This simplifies actuation of the second control element 358, but may create unbalanced forces when translating the output element 352, as it is moved by only the first control element 356.

FIG. 19 shows the second control element 358 rotated to disengage it from the output element 352, and the first control element 356 being translated, moving the output element 352 via the engagement of the protrusions 360 with the output element 352 (this step is comparable to the translation of the output element 302 as shown in FIG. 15). Once the output element 352 has been translated one step, the second control element 358 is rotated about the second control axis 364 to engage it with the output element 352, as shown in FIG. 20. The first control element 356 is then rotated about the first control axis 362 to disengage its protrusions 360 from the output element 352, after which it can be returned to its initial position by translating it along the first control axis 362, while the engagement of the second control element 358 with the output 352 holds it in place (this step is roughly comparable to the repositioning of the first control element 306 as shown in FIG. 16). Once returned to its initial position, the first control element 356 can be rotated to engage it with the output element 352, after which the second control element 358 can be rotated to disengage it from the output element 352 to allow the first control element 356 to move the output element 352 another step.

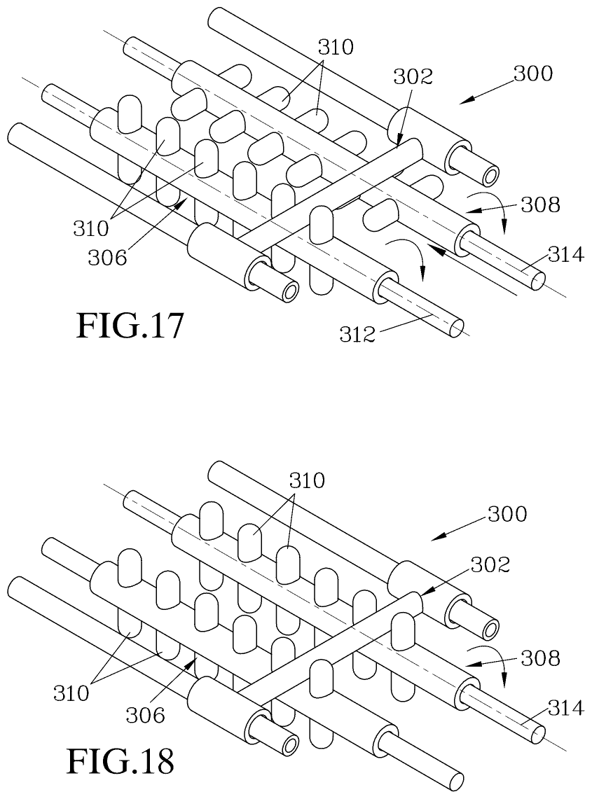

FIG. 21 illustrates a stepped linear drive 370 which operates similarly to either the drive 300 or the drive 350, but which employs van der Waals (VDW) forces to engage an output element 372 with a first control element 374 and/or a second control element 376. Rather than protrusions, each of the control elements (374, 376) is provided with a series of holes 378. When the control elements (374, 376) are provided by CNTs, the holes could be formed by smaller-diameter CNTs inserted into apertures in the wall of the larger CNTs. When one of the control elements (374, 376) is rotated so as to engage the output element 372 (as shown in FIG. 21 for the first control element 374), the holes 378 are positioned such that they bracket the output element 372. Each hole 378 creates an effective edge that the output element 372 cannot easily move past, because it would require work to overcome the VDW attraction between the output element 372 and the first control element 374 to push the output element 372 beyond the edge of either of the adjacent holes 378. So long as the resistance to axial motion of the output element 372 is less than the stiffness of force required to overcome VDW attraction, axial movement of the first control element 374 will cause the output element 372 to move with it. The use of VDW attraction to move parts in order to avoid the work of having a part move past an edge is disclosed in US Publication 2023/0238965, incorporated herein by reference.

When one of the control elements (374, 376) is rotated so as to disengage it from the output element 372 (as shown in FIG. 21 for the second control element 376), the holes 378 are rotated away from the output element 372 and thus the output element 372 can translate relative to the control element 376 without encountering an edge.

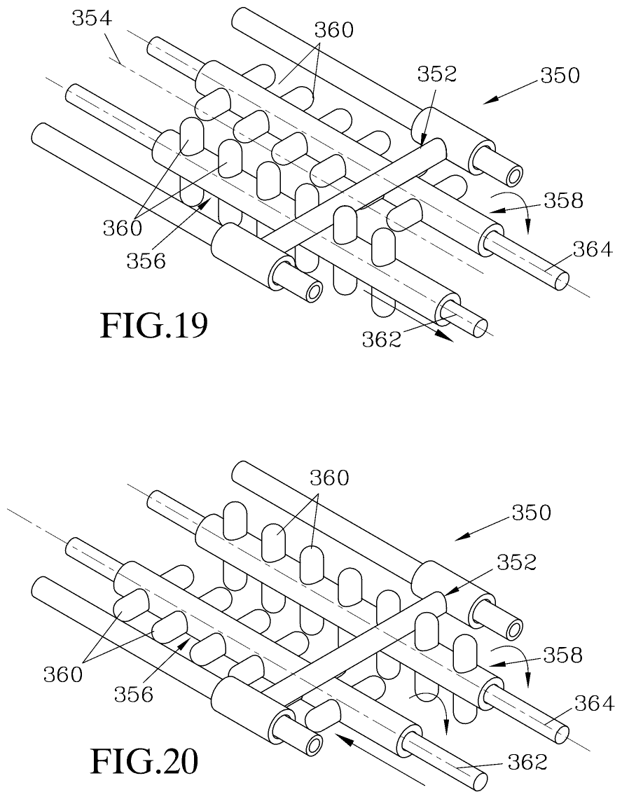

FIG. 22 illustrates a multiplexer 400 that illustrates one possible application of a stepped linear drive 402, which can be used to direct a motion signal from an input element 404 to a selected one of several channel elements 406. A transfer element 408 is slidably housed in an output element 410, and a pair of control elements 412 operate to position the output element 410 such that the transfer element 408 is positioned in alignment with the desired channel element 406. The control elements 412 can operate in a manner similar to the control elements (306 & 308 or 356 & 358) shown in FIGS. 14-20. Once the output element 410 has been positioned, motion of the input element 404 displaces the transfer element 408, which in turn displaces the aligned one of the channel elements 406. The multiplexer 400 allows a single actuator (not shown) that displaces the input element 404 to cause motion on multiple channels, which can be used to control mechanisms. While a translating motion element is illustrated, stepped linear drives such as discussed herein could also be used to position multiplexers that transmit rotary motion, such as those disclosed in U.S. Publication 2023/0296163, incorporated herein by reference.

FIG. 23 illustrates one example of a control motor 450 that could be used to operate a control element 452, to provide the control element 452 with both rotation about a control axis 454 and translational motion along the axis 454. The control element 452 is mounted to a stepper motor 456 which can be configured to provide rotation of the control element 452 in 90° steps, allowing a series of protrusions 458 on the control element 452 to either be positioned to engage an output element (not shown) or to be disengaged therefrom. The stepper motor 456 in turn is slidably mounted in a track 460 that extends parallel to the control axis 454. The position of the stepper motor 456 and the control element 452 mounted thereto along the track 460 is controlled by a linear actuator 462. While the control motor 450 is shown as an example, alternative motors, actuators, and/or mechanisms known for providing both rotational and translational motion could be employed.

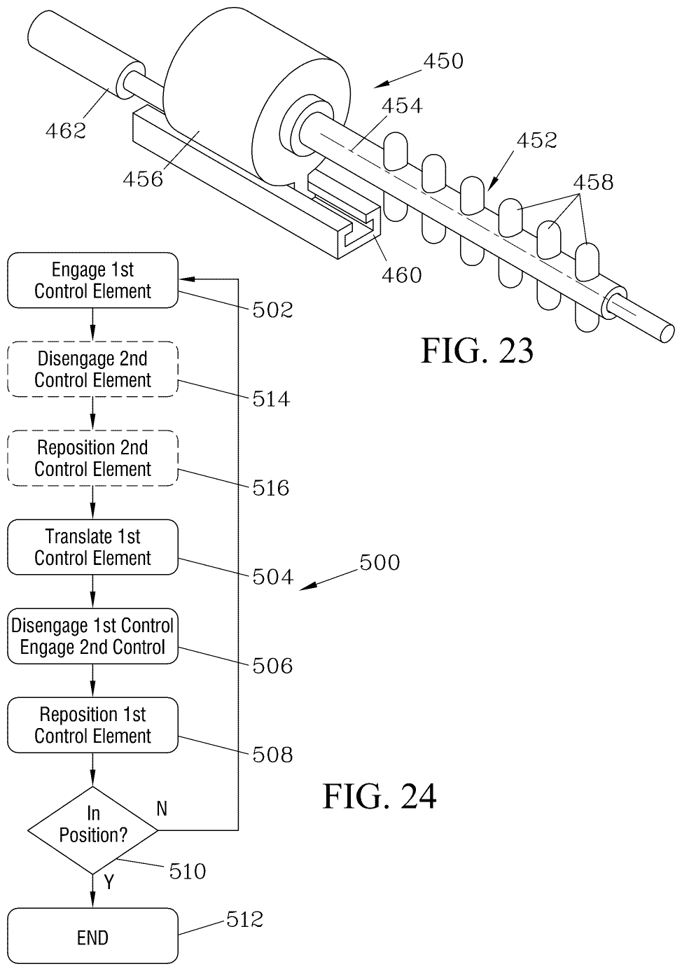

FIG. 24 illustrates a method 500 of moving an output element along a motion axis. The method comprises the steps of:
502—Engage the output element with a first control element;
504—Translate the first control element parallel to the motion axis;
506—Disengage the output element from the first control element and engage the output element with a second control element;
508—Reposition the first control element parallel to the motion axis;
510—Determine whether at desired position;
512—End;
514—(optional) Disengage the second control element and engage the output element with the control element; and
516—(optional) Reposition the second control element parallel to the motion axis.

The method begins by engaging the output element with a first control element (step 502). This engagement is accomplished without requiring translational motion of the first control element normal to the motion axis. Depending on the apparatus used to perform the method, options for such engagement may include engagement by resilient or frictional engagement, moving the output element (or a portion thereof) via cam surfaces, or rotating elements on the first control element into engagement with the output element (in which case engagement is achieved without translating the first control element). In some cases, a second control element is also engaged with the output element. Once engaged with the output element, the first control element is translated parallel to the motion axis so as to also translate the output element that is engaged with it (step 504). If the second control element is engaged with the output element, it is also translated in step 504.

After the output element has been translated in step 504, the output element is disengaged from the first control element and engaged with the second control element (step 506), if not already so engaged. Such engagement is accomplished without requiring translational motion of the second control element normal to the motion axis. Again, options for such engagement include engagement via resilient or frictional engagement, by moving the output element (or portion thereof) via cam surfaces, or by rotation of the second control element. In some cases, the second control element is engaged with the output element prior to translating the output element in step 504, in which case the second control element remains engaged with the output element in step 506 while the first control element is disengaged from the output element.

With the first control element disengaged from the output element and the second control element engaged with the output element in step 506, the first control element is repositioned parallel to the motion axis (step 508). At this time, engagement of the output element with the second control element prevents the output element from translating along the motion axis as the first control element is repositioned. A determination can be made (step 510) as to whether the output element is in its desired location. If so, then the movement process ends (step 512).

If it is determined in step 510 that the output element has not yet reached its desired location, the steps of engaging (502), translating (504), disengaging (506), and repositioning (508) the first control element can be repeated as many times as necessary to move the output element to a desired position on the motion axis.

In cases where the second control element is translated with the output element, additional steps to reposition the second control element are performed. In such cases, after the first control element has been repositioned (step 508) and engaged with the output element (step 502), the second control element is disengaged from the output element (step 514). The second control element can then be repositioned (step 516), while the engagement of the first control element with the output element serves to maintain the output element in position. Once both control elements have been repositioned, the second control element can be engaged with the output element and translated with the first control element when the first control element is translated in step 504.

The above discussion, which employs particular examples for illustration, should not be seen as limiting the spirit and scope of the appended claims.

What is claimed is:

1. A stepped linear drive mechanism comprising:
an output element translatable along a motion axis;
a first control element translatable parallel to the motion axis, said first control element being selectively engageable with said output element, said first control element has at least a portion that is restrained in space so as to have a fixed position relative to a plane orthogonal to the motion axis; and
a second control element translatable parallel to the motion axis, said second control element being selectively engageable with said output element, said second control element has at least a portion that is restrained in space so as to have a fixed position relative to a plane orthogonal to the motion axis,
the selective engagement of said first control element and said second control element with said output element allowing said output element to move with said control elements when both control elements are translated along the motion axis, and allowing one of said control elements to be moved while the other of said control elements and said output element remain stationary.

2. The drive mechanism of claim 2 wherein said first control element and said second control element are restrained so as to only be translatable along the motion axis.

3. The drive mechanism of claim 1 wherein said first control element and said second control element resiliently engage said output element via impedance structures.

4. The drive mechanism of claim 1 wherein each of said first control element and said second control element engage said output element via tabs bounded by cam elements and restraining elements.

5. The drive mechanism of claim 1 wherein said first control element and said second control element each rotatably engage said output element.

6. The drive mechanism of claim 5 wherein each of said first control element and said second control element has protrusions configured to engage said output element.

7. The drive mechanism of claim 5 wherein each of said first control element and said second control element has edges configured to engage said output element via van der Waals attraction.

8. A stepped linear drive mechanism comprising:
an output element translatable along a motion axis;
a first control element that is translatable parallel to the motion axis and is rotatably engageable with said output element; and
a second control element that is rotatably engageable with said output element and capable of restraining translation of said output element when engaged therewith,
wherein engagement of said first control element with said output element allows said first control element to translate said output element when engaged therewith and said output element is not restrained by said second control element, and allows said first control element to translate while said output element is restrained by said second control element when said first control element is not engaged with said output element.

9. The drive mechanism of claim 8 wherein said second control element can operate in the same manner as said first control element.

10. The drive mechanism of claim 8 wherein each of said first control element and said second control element has protrusions configured to engage said output element.

11. The drive mechanism of claim 8 wherein each of said first control element and said second control element has edges configured to engage said output element via van der Waals attraction.

12. A method of moving an output element along a motion axis, the method comprising the steps of:
engaging the output element with a first control element without requiring translational motion of the control element normal to the motion axis;
translating the first control element parallel to the motion axis so as to also translate the output element engaged therewith;
disengaging the output element from the first control element and engaging the output element with a second control element without requiring translational motion of the second control element normal to the motion axis;
repositioning the first control element parallel to the motion axis while engagement of the output element with the second control element prevents the output element from translating along the motion axis;
repeating said engaging, translating, disengaging, and repositioning of the first control element until the output element has been translated to a desired position on the motion axis.

13. The method of claim 12 further comprising the steps of:
disengaging the output element from the second control element and engaging the output element with the first control element; and
repositioning the second control element parallel to the motion axis while engagement of the output element with the first control element prevents the output element from translating along the motion axis.

14. The method of claim 12 wherein said step of engaging the output element with the first control element is performed without translating the first control element.
